(19) United States
(12) Patent Application Publication
(10) Pub. No.: US 2026/0218532 A1
(43) Pub. Date: Jul. 30, 2026

(54) TOWER AND RELATED METHOD FOR PROTECTING A TOWER AGAINST WIND-INDUCED VIBRATIONS

(71) Applicant: ISAAC S.R.L., Milano (IT)

(72) Inventors: Alberto BUSSINI, Milano (IT); Lorenzo BOGNI, Varano Borghi (VA) (IT); Fabio MENARDO, Vigevano (PV) (IT); Matteo ROSTI, Milano (IT); Giovanni REBECCHI, Poggio Renatico (FE) (IT); Stefano CII, Milano (IT); Fabio BOLOGNESI, Monza (MB) (IT); Andrea CODINA, Milano (IT); Francesco RIPAMONTI, Erba (CO) (IT)

(21) Appl. No.: 19/148,260

(22) PCT Filed: Dec. 13, 2023
(86) PCT No.: PCT/EP2023/085531

§ 371 Date: Jul. 15, 2025

(30) Foreign Application Priority Data
Jan. 16, 2023 (IT) 102023000000471

(51) Int. Cl. E04H 9/02; E04H 12/10; F16F 7/10; H01Q 1/00; H01Q 1/12

(52) U.S. Cl. CPC E04H 9/0215; E04H 12/10; F16F 7/1005; H01Q 1/005; H01Q 1/1242

(57) ABSTRACT

A tower includes a truss support structure that is elongated and upright and has a plurality of interconnected beams; at least one movable mass device with a chassis mechanically connected to the interconnected beams, at least one mass movable in at least one linear direction, at least one actuator that moves the at least one mass in a controlled manner; at least one sensor configured to detect a vibration of said truss support structure; and at least one control unit connected with the at least one sensor and the at least one actuator and configured to control an inertial movement of the at least one mass in real time in order to counteract vibration of said truss support structure.

### CROSS REFERENCES

This application is a U.S. National Phase Application of International Application No. PCT/EP2023/085531 filed Dec. 13, 2023, which claims priority to Italian Application No. 102023000000471 filed Jan. 16, 2023, the disclosures of each of which are hereby incorporated by reference herein in their entirety.

### TECHNICAL FIELD

The present disclosure relates to a tower comprising at least one movable mass device for protecting the tower against wind-induced vibrations.

The present disclosure relates to a method for protecting a tower against wind-induced vibrations.

The field of application of the present disclosure is the reduction of the effects of wind loads on towers, in particular towers with steel truss structures, such as broadcasting towers and telecommunication towers.

### BACKGROUND

Tower structures, such as transmission towers and telecommunication towers, are often made with truss structures made of steel.

The towers have an elongated and upright structure, and are therefore very slender and scarcely damped.

The towers thus particularly suffer from the vibrations induced by wind loads. These wind-induced vibrations can cause longitudinal, transversal or torsional movements of the tower, and even entail an aeroelastic instability of the structure.

This problem of vibrations is exacerbated in the event that heavy equipment, such as broadcasting or telecommunication apparatuses, are located on the tower, and in particular on top thereof.

This problem is even more exacerbated in the case of towers with truss support structures, which comprise a plurality of beams interconnected to each other.

In these cases, the dynamic characteristics of the truss tower are amplified by the low damping of the truss support structure. The wind loads can then generate high displacements and stresses to the support structure, potentially creating damages or even collapses of the tower itself.

It is known to use tuned mass passive dampers to mechanically increase the damping of the structure and then reduce the negative effects of wind loads on towers. However, these systems are particularly sensitive to the variations undergone by the structure over time and have weights usually around 5% of the overall mass of the structure. This also implies the need for an ad hoc design for different structures.

Document US20100226785A1 relates to a tower having a space frame structure for wind turbines. The tower comprises damping struts in the longitudinal elements of the space frame, in order to dampen vibrations generated by non-periodic wind gusts or at high wind speeds.

Document U.S. Pat. No. 5,065,552A relates to an active vibration response control system of a frame structure with posts and beams, wherein a variable damping device is interposed between elements of the frame and is controlled in case of strong wind.

Document CN114253308A relates to an active control method for the vibration of a space frame structure, wherein information about the structure acceleration is obtained by an acceleration sensor and a piezoelectric actuator placed on the structure and configured to apply a driving force is controlled according to a neural network prediction model.

However, known solutions are not fully effective in protecting a tower, in particular a tower with a truss support structure or space frame, against wind-induced vibrations.

### SUMMARY

An object of the present disclosure is to overcome some drawbacks of the prior art.

A particular object of the present disclosure is to provide a tower which is effectively protected against vibrations.

A further particular object of the present disclosure is to protect a tower against wind-induced vibrations.

A further particular object of the present disclosure is to counteract vibrations of a truss support structure which comprises a plurality of interconnected beams.

These and other objects are achieved by a tower and a method for protecting a tower against wind-induced vibrations according to the features of the appended claims, which form an integral part of the present description.

An idea underlying the present disclosure is to provide a tower comprising an elongated and upright truss support structure having a plurality of interconnected beams. The tower comprises at least one movable mass device comprising: a chassis mechanically connected to the plurality of interconnected beams; at least one mass configured for a movement in at least one linear direction; at least one actuator configured to move the at least one mass in a controlled manner. The tower further comprises at least one sensor configured to detect a vibration of the truss support structure. The tower further comprises at least one control unit operatively connected to the at least one sensor and to the at least one actuator. The at least one control unit is configured to control an inertial movement of the at least one mass in real time, in order to counteract the vibration of the truss support structure.

A further idea underlying the present disclosure is to provide a method for protecting a tower against wind-induced vibrations. The tower comprises an elongated and upright truss support structure with a plurality of interconnected beams. The method comprises providing the tower with at least one movable mass device. The movable mass device comprises: a chassis mechanically connected to the plurality of interconnected beams, at least one mass which is movable in at least one linear direction, at least one actuator to move the at least one mass in a controlled manner. The method comprises detecting a wind-induced vibration on the truss support structure by at least one sensor. The method comprises controlling an inertial movement of the at least one mass in real time in order to counteract the wind-induced vibration.

A further idea underlying the present disclosure is to provide a tower comprising an elongated and upright support structure and further comprising at least one movable mass device. The at least one movable mass device comprises: a chassis mechanically connected to said support structure, at least one mass configured for a movement in at least one linear direction, at least one actuator configured to move said at least one mass in a controlled manner. The tower further comprises: at least one sensor configured to detect a vibration of said support structure, and at least one control unit operatively connected to said at least one sensor and connected to said at least one actuator. The at least one control unit is configured to control an inertial movement of said at least one mass in real time, in order to counteract said vibration of said support structure.

A further idea underlying the present disclosure is to provide a method for protecting a tower against wind-induced vibrations. The tower comprises an elongated and upright support structure. The method comprises: providing said tower with at least one movable mass device comprising: a chassis mechanically connected to said support structure, at least one mass which is movable in at least one linear direction, at least one actuator to move said at least one mass in a controlled manner; detecting a vibration induced by wind on said support structure by at least one sensor; controlling an inertial movement of said at least one mass in real time in order to counteract said wind-induced vibration.

The present disclosure allows to effectively protect a tower against vibrations, in particular against wind-induced vibrations.

The present disclosure allows in particular to effectively counteract vibrations of a truss support structure which comprises a plurality of interconnected beams.

Advantageously, the movable mass device according to the present disclosure constitutes an active mass damper, particularly suitable for the application on truss support structures having interconnected beams, such as steel truss towers.

The tower protection system comprising the at least one movable mass device, the at least one sensor and the at least one control unit are configured to generate a stabilizing force on the tower structure, and thus a damping effect on the dynamic properties of the structure itself in order to decrease the maximum displacement reached by the tower due to the wind-induced loads.

The at least one control unit, for example a central computer, advantageously allows to remotely or automatically update the active control algorithm of the at least one movable mass device, in order to make the system adaptive to every potential change in the tower structure.

Advantageously, the present disclosure is applicable to a very wide range of towers, such as towers with truss support structures having interconnected beams, with no need for substantial variations to the movable mass device, which can therefore represent a widely used modular unit.

Advantageously, the mass of the at least one movable mass device is considerably reduced with respect to the overall mass of the tower structure. In addition, the mass of the at least one sensor and of the at least one control unit is substantially negligible with respect to the overall mass of the tower structure.

Advantageously, being it possible to vary in a modular manner the configuration of the one or more movable mass devices associated with the tower, it is not necessary to design a specific solution for each tower, but to act within the algorithm of the control unit.

Advantageously, the present disclosure is particularly effective in protecting a tower within a wide range of frequencies, typically comprised between 0.5-10.0 Hz; in this regard, the disclosure is effective for a range which is wider than a single specific design frequency.

Moreover, advantageously, by an accurate control of the movement of the at least one mass movable by the at least one actuator, it is possible to effectively and simultaneously act on all the frequencies which are specific to the structure, for example within the range 0.5-10.0 Hz.

Preferably, the at least one linear direction for the movement of said at least one mass is at least partially transversal to a development axis of said truss support structure. Advantageously, the arrangement of the movable mass device is particularly effective in order to counteract vibrations of the tower structure, in particular wind-induced vibrations.

Preferably, the tower comprises two linearly movable masses, or a mass which is movable on two independent directions. Preferably, the movement of the at least one movable mass is controlled in two linear directions on respective planes which are perpendicular to each other. Advantageously, this configuration allows to counteract vibrations of the tower structure along the two axes, in particular vibrations induced by winds which can come from a plurality of different spatial directions.

Further features and advantages will be more apparent from the following detailed description of preferred non-limiting embodiments of the present disclosure, and from the dependent claims which outline preferred and particularly advantageous embodiments of the present disclosure.

These and other aspects are merely illustrative of the innumerable aspects associated with the present disclosure and should not be deemed as limiting in any manner. These and other aspects, features, and advantages of the present disclosure will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the present disclosure and wherein similar reference characters indicate the same parts throughout the views.

FIG. 1 illustrates examples of towers having truss support structures.

FIG. 2 illustrates an example of a tower protected against wind-induced vibrations, according to the present disclosure.

FIG. 3 illustrates a diagram which exemplifies the operation of the present disclosure.

FIG. 4 illustrates a further example of a tower protected against wind-induced vibrations, according to the present disclosure.

FIG. 5 illustrates a further example of a tower protected against wind-induced vibrations, according to the present disclosure.

FIG. 6 illustrates a further example of a tower protected against wind-induced vibrations, according to the present disclosure.

FIG. 7 illustrates a further example of a tower protected against wind-induced vibrations, according to the present disclosure.

FIG. 8 illustrates a detail of a tower having a first embodiment of a movable mass device according to the present disclosure.

FIG. 9 illustrates a detail of a tower having a second embodiment of a movable mass device according to the present disclosure.

FIG. 10 illustrates a detail of a tower having a third embodiment of a movable mass device according to the present disclosure.

FIG. 11 illustrates a detail of a tower having a fourth embodiment of a movable mass device according to the present disclosure.

FIG. 12 illustrates a detail of a tower having a fifth embodiment of a movable mass device according to the present disclosure.

FIG. 13 illustrates a further example of a tower, without a truss structure, protected against wind-induced vibrations, according to the present disclosure.

In the various figures, analogous elements will be identified by analogous reference numbers. If a plurality of elements are present in a same figure, sometimes only one or some of those will be indicated with a reference number, for simplicity, meaning that the other ones are also encompassed in the description.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. The following definitions and non-limiting guidelines must be considered in reviewing the description of the technology set forth herein.

In the following detailed description numerous specific details are set forth in order to provide a thorough understanding of the present disclosure. However, it will be understood by those skilled in the art that the present disclosure may be practiced without these specific details. For example, the present disclosure is not limited in scope to the particular type of industry application depicted in the figures. In other instances, well-known methods, procedures, and components have not been described in detail so as not to obscure the present disclosure.

The headings and sub-headings used herein are intended only for general organization of topics within the present disclosure and are not intended to limit the disclosure of the technology or any aspect thereof. In particular, subject matter disclosed in the “Background” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

The citation of references herein does not constitute an admission that those references are prior art or have any relevance to the patentability of the technology disclosed herein. All references cited in the “Detailed Description” section of this specification are hereby incorporated by reference in their entirety.

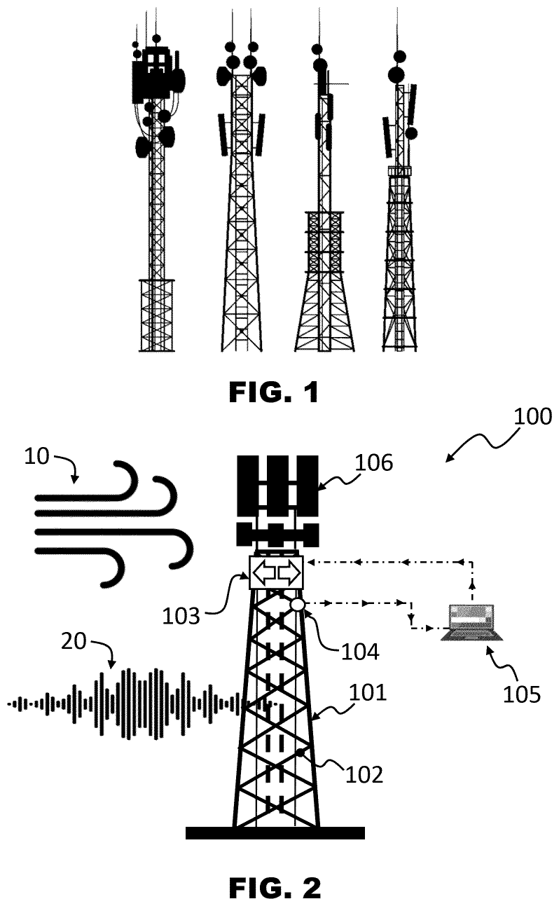

FIG. 1 illustrates examples of towers having truss support structures.

In general, a tower has an elongated and upright support structure. A truss support structure of a tower comprises a plurality of beams interconnected to each other.

Towers with truss support structures are typically made with steel beams, and are typically used for telecommunication and broadcasting; for this purpose they are often overloaded with antennas, parables, satellite dishes, etc.

A tower with an elongated and upright support structure is affected by problems related to wind-induced loads. Dynamic loads are introduced by turbulent wind or by the interaction of the wind flow with specific areas of the structure. High dynamic loads can loosen the bolted junctions or weaken the beam elements for fatigue mechanisms, particularly weakening the towers having truss support structures. Moreover, high dynamic loads can exceed the strength limits of the construction material or induce balance instability phenomena of the interconnected beams composing the truss support structure.

FIG. 2 illustrates an example of a tower 100 protected against wind-induced vibrations.

The tower 100 comprises an elongated and upright truss support structure 101. The truss support structure 101 comprises a plurality of interconnected beams 102.

In general, the tower 100 is subject to wind-induced loads 10. The tower 100 comprises a system for reducing the vibrations/oscillations according to the present disclosure.

The tower 100 comprises a movable mass device 103; in an alternative the tower could comprise two or more movable mass devices 103.

In general, a movable mass device 103 comprises a chassis mechanically connected to the plurality of interconnected beams 102. “Mechanically connected” means mechanically connected in a direct or indirect manner to one or more of the interconnected beams composing the truss support structure 101.

In general, a movable mass device 103 comprises at least one mass configured for a movement in at least one linear direction. In general, a movable mass device 103 comprises at least one actuator configured to move the at least one mass in a controlled manner.

The tower 100 further comprises at least one sensor 104 configured to detect a vibration 20 of the truss support structure 101. For example, the sensor 104 is an accelerometer.

The tower 100 further comprises at least one control unit 105, schematized here for example by a computer, which is operatively connected to the at least one sensor 104 and to the at least one actuator of the movable mass device 103, as schematized by the dotted arrows.

The at least one control unit 105 is configured to control an inertial movement of the at least one mass of the movable mass device 103 in real time, in order to counteract the vibration 20 of the truss support structure 101.

Preferably, the at least one control unit 105 is further configured to receive information about the ongoing vibration 20 in real time and to calculate according to a control algorithm the inertial movement of the mass of the movable mass device 103.

Preferably, the linear direction for the movement of the at least one mass of the movable mass device 103 is at least partially transversal to a development axis, that is a longitudinal axis, of the truss support structure 101, as exemplified by the right/left arrows in the example of the movable mass device 103 which is transversal to the vertical development axis of the tower 100.

Preferably, the tower 100 is of the type with at least one telecommunication apparatus 106 on top of the truss support structure 101.

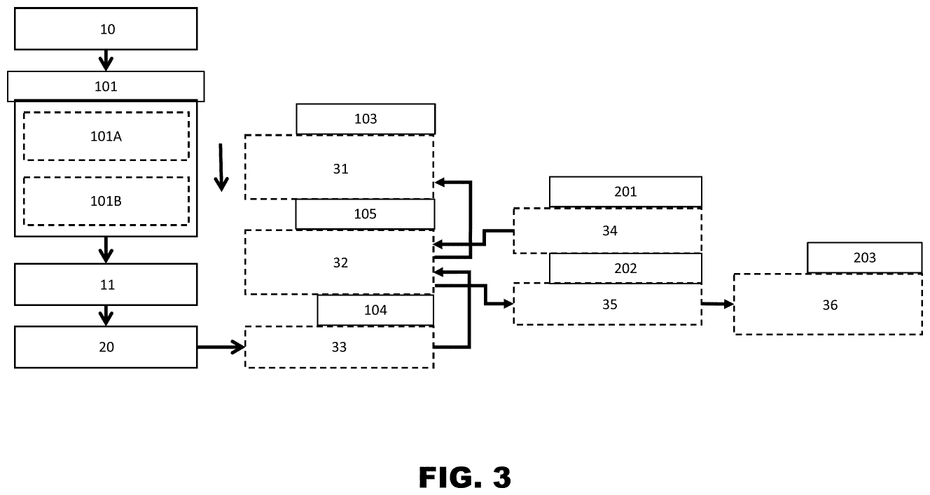

FIG. 3 illustrates a diagram which exemplifies the operation of the present disclosure.

The wind 10 hits the truss support structure 101 of the tower 100, inducing aerodynamic effects 101A around the structure 101 and inducing dynamic effects 101B of the structure 101 itself.

The wind 10 thus generates a load 11, which involves a vibration 20 of the tower 100.

The movable mass device 103 is configured to generate an active control force 31 of the inertial type.

The at least one control unit 105 is configured to calculate the inertial movement of the mass of the movable mass device 103 according to a control algorithm 32.

The at least one sensor 104 is configured for a detection 33 of the vibration 20, to be provided to the at least one control unit 105 as an input of the control algorithm 32, to determine the active control force 31 in real time.

Moreover, preferably, the system provides a remote connection 201 through which it is possible to perform a remote maintenance 34.

Moreover, preferably, the system provides a Cloud infrastructure 202 which allows a data post-processing 35 to be performed.

Through the data post-processing 35, a certification module 203 is preferably adapted for a structural health monitoring 36 of the tower 100.

In an example, the vibratory movement 20 of the structure 101 is measured by one or more accelerometers 104 and data are processed in the at least one control unit 105 by an active control algorithm 32; the at least one control unit 105, given the measured acceleration 33, calculates and controls the reference position of the active masses which are present in the inertial actuators in order to generate forces 31 which stabilize the structure 101, creating a damping effect on the dynamic properties of the tower 100.

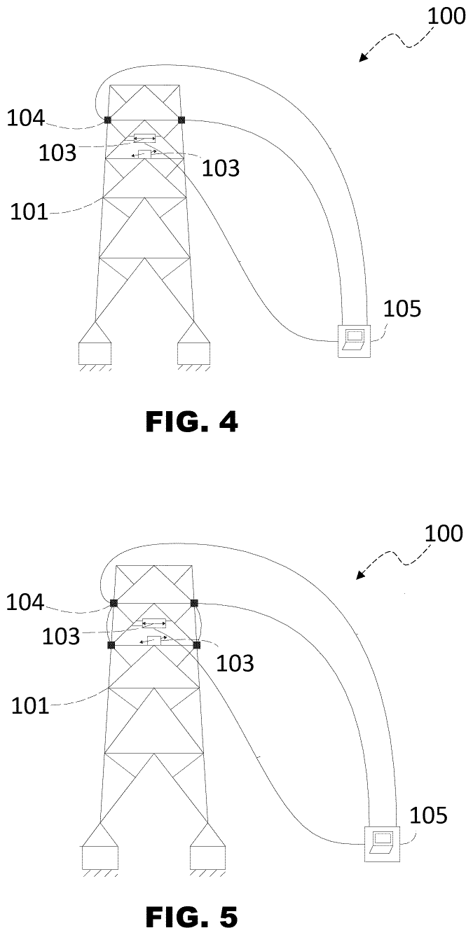

FIG. 4 illustrates a further example of a tower 100, comprising two movable mass devices 103, whose masses are configured for respective movements in two linear directions on respective planes which are perpendicular to each other, as exemplified by the arrows associated with these elements.

Moreover, the tower 100 comprises two sensors 104, in particular accelerometers. Preferably, the sensors 104 have each a sensing axis aligned with a respective linear direction of a respective one of the two masses of the two movable mass devices 103.

Other sensors can be embedded in the system such as anemometers, temperature sensors and the like.

As a variant, not represented, of the two movable mass devices 103, a single movable mass device could comprise a mass configured for a simultaneous movement in two linear directions which are perpendicular to each other on a unique plane. Preferably, in this alternative, the single movable mass device would further comprise two actuators, for the movement in each of the two linear directions, respectively; in other words, the two actuators act on the single mass of the movable mass device by a double-axis control.

FIG. 5 illustrates a further example of a tower 100 in which there is a plurality of sensors 103, in particular four sensors 104, applied to the truss support structure 101.

Preferably, the sensors 104 are positioned at different heights along an extension of the truss support structure 101.

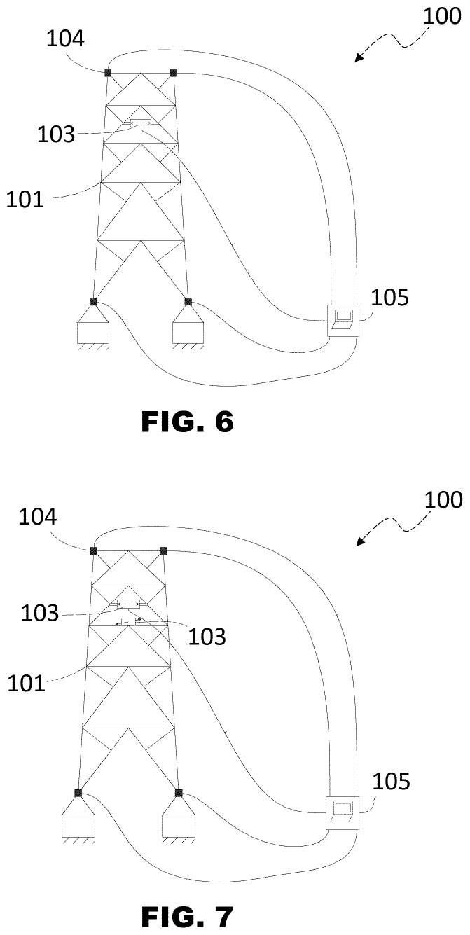

FIG. 6 and FIG. 7 illustrate further examples of towers 100 protected against wind-induced vibrations, according to further embodiments.

In these examples, there are four sensors 104, two applied to the truss support structure 101 and two to the base of the truss support structure 101, respectively, thus positioned at different heights.

In the example of FIG. 6, there is a single movable mass device 103, while in the example of FIG. 7 there are two movable mass devices 103, which are similar to the examples of the above-discussed FIGS. 4 and 5.

The masses of the two movable mass devices 103 are configured for respective movements in two linear directions on respective planes which are perpendicular to each other, as exemplified by the arrows associated with these elements.

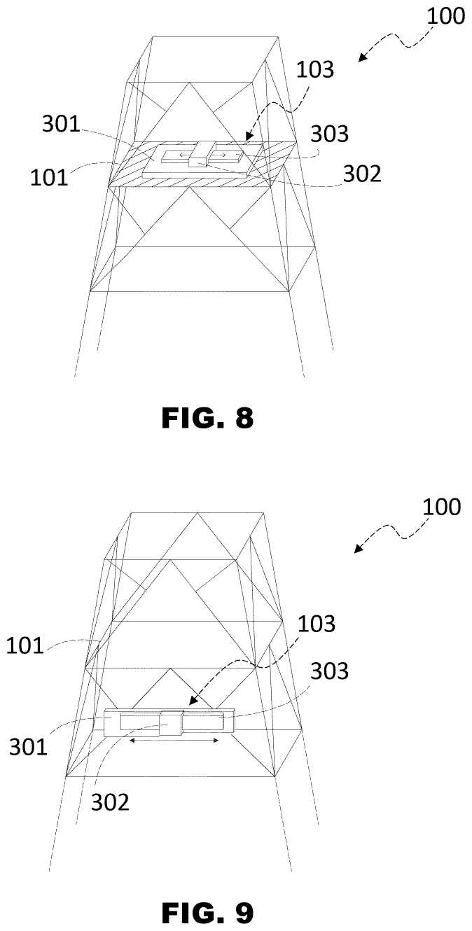

FIG. 8 illustrates a detail of a tower 100 having a first embodiment of a movable mass device 103.

In general, a movable mass device 103 comprises a chassis 301 mechanically connected to the plurality of interconnected beams, that is globally mechanically connected to the truss support structure 101.

In general, a movable mass device 103 comprises at least one mass 302 configured for a movement in at least one linear direction, exemplified by the arrows in the Figure. The at least one mass 302 is movably supported by the chassis 301.

In general, a movable mass device 103 comprises at least one actuator 303, schematized in a simplified way in the Figure; the actuator 303 is configured to move the at least one mass 302 in a controlled manner.

The actuator 303, which converts the energy provided by a power supply into the kinetic energy of the inertial mass 302, can be embedded in the chassis 301, for example with a rotary electric motor which drives a ball screw transmission.

Alternatively, the actuator 303 can be embedded in the mass 302 itself, for example using a rotary drive and a rack and pinion transmission.

Yet an alternative option is to generate the mechanical power required for the movement of the mass 302 exploiting the interaction between elements placed both on the chassis 301 and on the linear mass 302, as it occurs, for example, in a linear electric motor. The actuator 303 can thus comprise a plurality of elements with even diffused configurations within the movable mass device 103.

In the example, the chassis 301 comprises a plate base leaning on a horizontal deck of the tower 100.

In general, the movable mass device 103 could comprise a protection carter at least partially covering the mass movable 302, not represented in these examples for simplicity of view.

FIG. 9 illustrates a detail of a tower 100 having a second embodiment of a movable mass device 103.

The movable mass device 103 comprises a chassis 301, at least one mass 302 and at least one actuator 303 according to what has been described.

In this example, the chassis 301 comprises a plate base flipped on a side and vertically anchored to the plurality of interconnected beams, that is globally mechanically connected to the truss support structure with the chassis 301 in a flipped and vertical configuration.

The chassis 301 could be anchored to horizontal beams, or to upright or skew structural elements.

The advantage of this second embodiment of the movable mass device 103 is to free some space on a possible horizontal deck of the tower 100, or to allow the installation on a tower 100 having a size which is reduced and such as not to have any available horizontal deck.

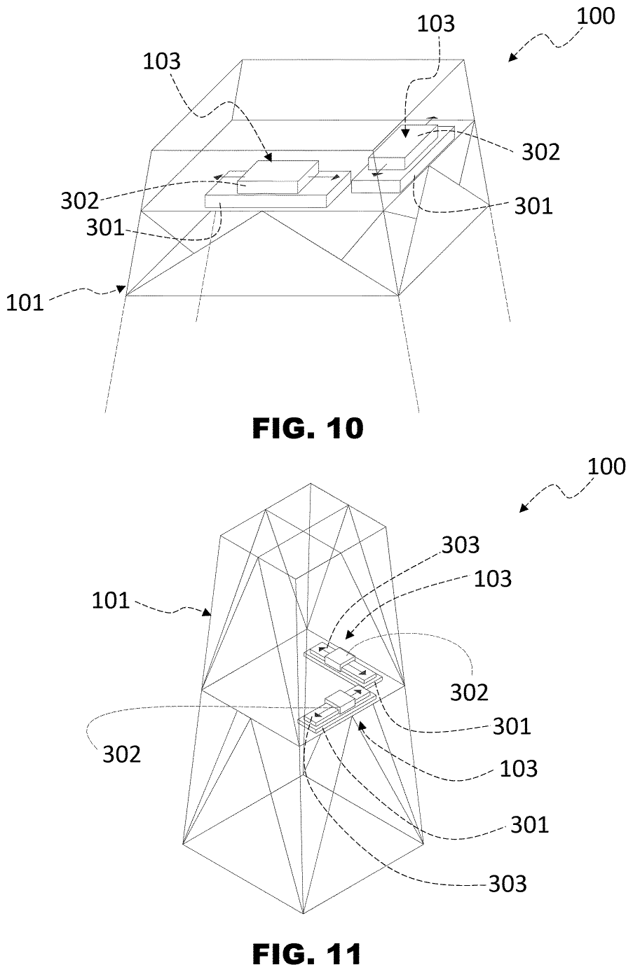

FIG. 10 illustrates a detail of a tower 100 having a third embodiment of a movable mass device 103, while FIG. 11 illustrates a detail of a tower 100 having a fourth embodiment of a movable mass device 103.

In both examples, there are two movable mass devices 103, which are similar to the examples of the above-discussed FIGS. 4, 5 and 7.

The masses 302 of the two movable mass devices 103 are configured for respective movements in two linear directions on respective planes which are perpendicular to each other, as exemplified by the arrows associated with these elements. The two linear directions can be understood as Cartesian directions X and Y, in order to effectively counteract vibratory movements of the tower 100 in space, which can be mainly decomposed on said directions X and Y.

The two respective chassis 301 are also indicated, while the actuators are not represented for simplicity but are meant to be present for the movement of the respective mass 302 in a controlled manner.

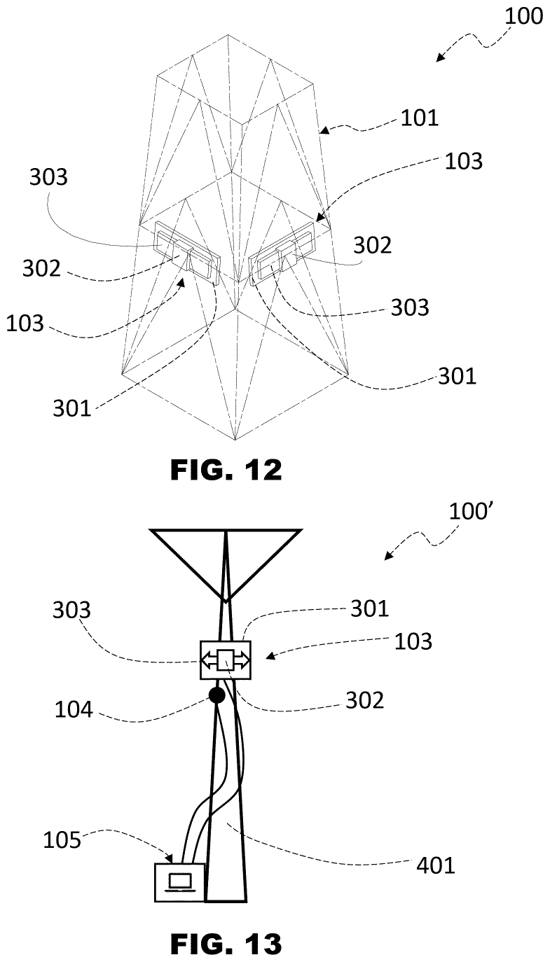

FIG. 12 illustrates a detail of a tower 100 having a fifth embodiment of a movable mass device 103.

In this example, there are two movable mass devices 103, similar to the examples of the above-discussed FIGS. 4, 5, 7, 10 and 11.

The masses 302 of the two movable mass devices 103 are configured for respective movements in two linear directions on respective planes which are perpendicular to each other, as exemplified by the arrows associated with these elements.

Moreover, each chassis 301 comprises a respective plate base flipped on a side and vertically anchored to the plurality of interconnected beams, that is globally mechanically connected to the truss support structure 101 with the chassis 301 in a flipped and vertical configuration.

It is thus evident that one or more movable mass devices 103 are associated with the tower 100, allowing a plurality of configurations selected in the design phase, for example taking into account the average wind stresses, the inertial mass of each of the movable masses, the number of movable mass devices and the structural configuration of the tower 100.

In general, the present disclosure provides a method for protecting a tower 100 against wind-induced vibrations. The tower 100 comprises an elongated and upright truss support structure 101 with a plurality of interconnected beams 102.

The present disclosure thus represents a method for increasing the dynamic damping of a tower 100, which is subject in particular to wind-induced vibrations.

It is provided to provide the tower 100 with at least one movable mass device 103 comprising: a chassis 301 mechanically connected to the plurality of interconnected beams 102, at least one mass 302 which is movable in at least one linear direction, at least one actuator 303 to move the at least one mass 302 in a controlled manner.

It is provided to detect a wind-induced vibration on the truss support structure 101 by at least one sensor 104.

It is provided to control an inertial movement of the at least one mass 302 in real time in order to counteract the wind-induced vibration.

In general, the method for protecting a tower 100 against wind-induced vibrations is adapted to provide a tower 100 according to what has been described above. In other words, the features described in connection with the tower 100 are applied by the corresponding method for protecting a tower according to the present disclosure.

In a further alternative, represented in FIG. 13, the tower 100′ could comprise an elongated and upright support structure 401, and at least one movable mass device 103.

The movable mass device 103 comprises: a chassis 301 mechanically connected to the support structure 401; at least one mass 302 configured for a movement in at least one linear direction; at least one actuator 303 configured to move the at least one mass 302 in a controlled manner.

The tower 100′ further comprises at least one sensor 104 configured to detect a vibration of the support structure.

The tower 100′ further comprises at least one control unit 105 operatively connected to the at least one sensor 104 and to the at least one actuator 303. The at least one control unit 105 is configured to control an inertial movement of the at least one mass 302 in real time in order to counteract the vibration of the support structure 401.

In other words, in this further alternative, it is provided that the tower 100′ comprises a generic elongated and upright support structure 401, which is however not necessarily a truss support structure 101.

In this regard, the generic elongated and upright support structure 401 of the tower 100′ does not necessarily comprise a plurality of interconnected beams, but it could comprise different tower structural elements, such as one or more pylons, for example made of steel or of reinforced concrete.

In this further alternative, the method for protecting a tower against wind-induced vibrations makes provision to provide the tower 100′ with at least one movable mass device 103, whose chassis 301 is mechanically connected to the support structure 401.

In this case too, the at least one movable mass device 103 is likewise similar to what has been described above with reference to truss support structures.

### INDUSTRIAL APPLICABILITY

Advantageously, the present disclosure allows to protect a tower against vibrations, in particular against wind-induced vibrations.

The present disclosure is particularly effective in towers having an elongated and upright support structure, in particular a steel truss support structure with natural frequencies comprised between 0.5 Hz and 10.0 Hz.

In general, the present disclosure is particularly effective in low damping structures, that is a damping which is equal or lower than 1% on the first vibration mode.

Considering the here-mentioned description, the skilled in the art will be allowed to devise further modifications and alternatives, in order to meet contingent and specific requirements.

It is evident that, where there are no technical incompatibilities which are clear to the skilled in the art, the configurations of specific elements described with reference to certain embodiments, could be used in other here-described embodiments.

For example, the specific construction of the at least one movable mass device could be configured based on specific requirements and design criteria.

The preferred embodiments of the disclosure have been described above to explain the principles of the present disclosure and its practical application to thereby enable others skilled in the art to utilize the present disclosure. However, as various modifications could be made in the constructions and methods herein described and illustrated without departing from the scope of the present disclosure, it is intended that all matter contained in the foregoing description or shown in the accompanying drawings, including all materials expressly incorporated by reference herein, shall be interpreted as illustrative rather than limiting. Thus, the breadth and scope of the present disclosure should not be limited by the above-described exemplary embodiment but should be defined only in accordance with the following claims appended hereto and their equivalents.

1-16. (canceled)

17. A tower, comprising:
an elongated and upright support structure;
at least one movable mass device, said at least one movable mass device comprising:
a chassis mechanically connected to said support structure;
at least one mass configured for a movement in at least one linear direction; and
at least one actuator configured to move said at least one mass in a controlled manner;
and wherein said tower further comprises:
at least one sensor configured to detect a vibration of said support structure; and
at least one control unit operatively connected to said at least one sensor and to said at least one actuator, said at least one control unit being configured to control an inertial movement of said at least one mass in real time in order to counteract said vibration of said support structure.

18. The tower according to claim 17, wherein said at least one linear direction for the movement of said at least one mass is at least partially transversal to a development axis of said support structure.

19. The tower according to claim 17, wherein said at least one sensor comprises at least one accelerometer.

20. The tower according to claim 17, wherein said at least one sensor has at least one sensing axis aligned with said at least one linear direction.

21. The tower according to claim 17, wherein said at least one control unit is further configured to receive information about said vibration in real time and to calculate said inertial movement according to a control algorithm.

22. The tower according to claim 17, wherein said tower comprises two of said movable mass devices, wherein said at least one mass of each of said two movable mass devices are configured for respective movements in two linear directions on respective planes which are perpendicular to each other.

23. The tower according to claim 17, wherein said movable mass device comprises:
a mass configured for a simultaneous movement in two linear directions which are perpendicular to each other on a unique plane; and
two actuators for each of said two linear directions, respectively, configured for a double-axis control.

24. The tower according to claim 17, wherein said chassis comprises a plate base leaning on a horizontal deck of said tower.

25. The tower according to claim 17, wherein said support structure is a truss support structure comprising a plurality of interconnected beams;
wherein said chassis is mechanically connected to said plurality of interconnected beams;
wherein said at least one sensor is configured to detect a vibration of said truss support structure; and
wherein said at least one control unit is configured to control an inertial movement of said at least one mass in real time to counteract said vibration of said truss support structure.

26. The tower according to claim 25, wherein said chassis comprises a plate base flipped on a side and vertically anchored to said plurality of interconnected beams.

27. The tower according to claim 25, said tower further comprising at least one telecommunication apparatus on said truss support structure.

28. The tower according to claim 25, wherein said at least one sensor comprises a plurality of sensors applied to said truss support structure, at different heights along an extension of said truss support structure.

29. A method for protecting a tower against wind-induced vibrations, wherein said tower comprises an elongated and upright support structure, said method comprising the steps of:
providing said tower with at least one movable mass device comprising: a chassis mechanically connected to said support structure, at least one mass which is movable in at least one linear direction, at least one actuator to move said at least one mass in a controlled manner;
detecting a vibration induced by wind on said support structure by at least one sensor; and
controlling an inertial movement of said at least one mass in real time in order to counteract said wind-induced vibration.

30. The method of claim 29, wherein said elongated and upright support structure comprises a truss support structure with a plurality of interconnected beams and said chassis is mechanically connected to said plurality of interconnected beams, and further comprising the step of detecting a vibration induced by wind on said truss support structure by said at least one sensor.

31. The method of claim 29, wherein said tower further comprises:
at least one sensor configured to detect a vibration of said support structure;
at least one control unit operatively connected to said at least one sensor and to said at least one actuator; and
wherein said at least one control unit is configured to control an inertial movement of said at least one mass in real time in order to counteract said vibration of said support structure.
